(19) United States
(12) Patent Application Publication
(10) Pub. No.: US 2026/0153716 A1
(43) Pub. Date: Jun. 4, 2026

(54) OPTICAL DEVICE AND HEAD-MOUNTED DISPLAY

(71) Applicant: Sharp Kabushiki Kaisha, Sakai City (JP)

(72) Inventor: Naru USUKURA, Sakai City (JP)

(21) Appl. No.: 19/398,343

(22) Filed: Nov. 24, 2025

(30) Foreign Application Priority Data
Nov. 29, 2024 (JP) 2024-208611

(51) Int. Cl. G02B 17/08; G02B 5/30

(52) U.S. Cl. CPC G02B 17/0804; G02B 5/3025

(57) ABSTRACT

A first reflective polarizing layer and a second reflective polarizing layer, a half mirror located between the first reflective polarizing layer and the second reflective polarizing layer, a first lens located between the first reflective polarizing layer and the half mirror, and a second lens located between the second reflective polarizing layer and the half mirror are included, in which the first lens and the second lens are plano-convex lenses each having a plane on a side close to the half mirror, the first reflective polarizing layer is disposed along a convex surface of the first lens, the second reflective polarizing layer is disposed along a convex surface of the second lens, the first reflective polarizing layer transmits first polarized light and reflects second polarized light, and the second reflective polarizing layer reflects one of the first polarized light and the second polarized light and transmits the other.

### CROSS-REFERENCE TO RELATED APPLICATIONS

This application claims the benefit of priority to Japanese Patent Application Number 2024-208611 filed on Nov. 29, 2024. The entire contents of the above-identified application are hereby incorporated by reference.

### BACKGROUND

### Technical Field

The disclosure relates to an optical device and a head-mounted display.

WO 2021/200428 A1 discloses an optical element including a first absorptive linear polarizer, a first reflective linear polarizer, a first retarder, a partially reflective mirror, a second retarder, and a second reflective linear polarizer in this order.

### SUMMARY

In the optical element disclosed in WO 2021/200428 A1, the optical system is long, and thus, it is difficult to reduce the size.

An optical device according to an aspect of the disclosure includes a first reflective polarizing layer and a second reflective polarizing layer, a half mirror located between the first reflective polarizing layer and the second reflective polarizing layer, a first lens located between the first reflective polarizing layer and the half mirror, and a second lens located between the second reflective polarizing layer and the half mirror, in which the first lens is a plano-convex lens having a plane on a side close to the half mirror, the second lens is a plano-convex lens having a plane on a side close to the half mirror, the first reflective polarizing layer is disposed along a convex surface of the first lens, the second reflective polarizing layer is disposed along a convex surface of the second lens, the first reflective polarizing layer transmits first polarized light and reflects second polarized light, and the second reflective polarizing layer reflects one of the first polarized light and the second polarized light and transmits the other.

According to an aspect of the disclosure, an optical device having a reduced size can be achieved.

### BRIEF DESCRIPTION OF DRAWINGS

The disclosure will be described with reference to the accompanying drawings, wherein like numbers reference like elements.

FIG. 1 is a cross-sectional view illustrating a configuration example of an optical device according to the present embodiment.

FIG. 2 is a schematic view illustrating two optical paths (double path) of the optical device of FIG. 1.

FIG. 3 is a cross-sectional view illustrating a configuration example of an optical device according to the present embodiment.

FIG. 4 is a cross-sectional view illustrating a configuration example of an optical device according to the present embodiment.

FIG. 5 is a cross-sectional view illustrating a configuration example of an optical device according to the present embodiment.

FIG. 6 is a cross-sectional view illustrating a configuration example of an optical device according to the present embodiment.

FIG. 7 is a schematic view illustrating two optical paths (double path) of the optical device of FIG. 6.

FIG. 8 is a cross-sectional view illustrating a configuration example of an optical device according to the present embodiment.

FIG. 9 is a cross-sectional view illustrating a configuration example of an optical device according to the present embodiment.

FIG. 10 is a cross-sectional view illustrating a configuration example of an optical device according to the present embodiment.

FIG. 11 is a cross-sectional view illustrating a configuration example of an optical device according to the present embodiment.

FIG. 12 is a schematic view illustrating two optical paths (double path) of the optical device of FIG. 11.

FIG. 13 is a flowchart illustrating an example of a manufacturing method for an optical device.

FIG. 14 is a cross-sectional view illustrating an example of the manufacturing method for an optical device.

FIG. 15 is a cross-sectional view illustrating an example of the manufacturing method for an optical device.

FIG. 16 is a table showing a relationship of an adhesion accuracy of a reflective polarizing layer and a combination of a thickness of the reflective polarizing layer and a radius of curvature of a convex surface of a lens.

FIG. 17 is a cross-sectional view illustrating a total thickness from a display device to a convex surface of a second lens.

FIG. 18 is a graph showing a relationship between a radius of curvature of a convex surface of a lens and a total thickness.

FIG. 19 is a side view illustrating a configuration example of a head-mounted display according to the present embodiment.

### DESCRIPTION OF EMBODIMENTS

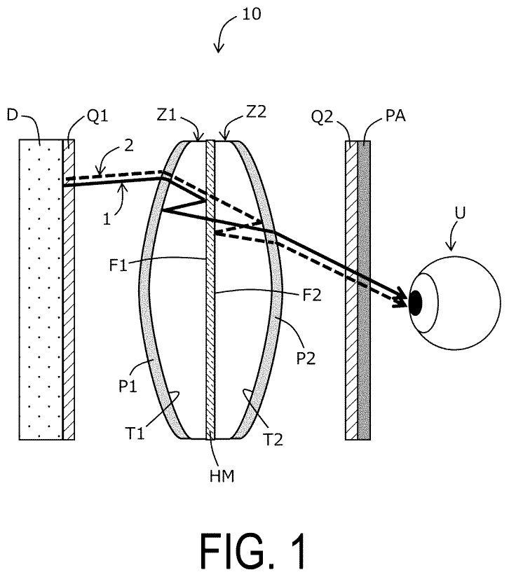

FIG. 1 is a cross-sectional view illustrating a configuration example of an optical device according to the present embodiment. The optical device 10 illustrated in FIG. 1 includes a first reflective polarizing layer P1, a second reflective polarizing layer P2, a half mirror HM, a first lens Z1, and a second lens Z2. The half mirror HM is located between the first reflective polarizing layer P1 and the second reflective polarizing layer P2. The first lens Z1 is located between the first reflective polarizing layer P1 and the half mirror HM. The second lens Z2 is located between the second reflective polarizing layer P2 and the half mirror HM. The optical device 10 is located between a display device D and a viewer U, and the first reflective polarizing layer P1, the first lens Z1, the half mirror HM, the second lens Z2, and the second reflective polarizing layer P2 are located in this order from the display device D toward the viewer U. The half mirror HM is an optical element having a characteristic of reflecting a part of incident light and transmitting the other part of the incident light.

The first lens Z1 is a plano-convex lens in which a surface on a side close to the half mirror HM is a plane F1 and a surface on a side far from the half mirror HM (a surface on a side close to the display device D) is a convex surface T1. The second lens Z2 is a plano-convex lens in which a surface on a side close to the half mirror HM is a plane F2 and a surface on a side far from the half mirror HM (a surface on a side close to the viewer U) is a convex surface T2. The convex surfaces T1 and T2 may be curved surfaces.

The first reflective polarizing layer P1 is disposed along the convex surface T1 of the first lens Z1. The second reflective polarizing layer P2 is disposed along the convex surface T2 of the second lens Z2. The first reflective polarizing layer P1 and the convex surface T1 may be in contact with each other or may be separated from each other. The second reflective polarizing layer P2 and the convex surface T2 may be in contact with each other or may be separated from each other.

The first reflective polarizing layer P1 transmits a first polarized light and reflects a second polarized light. The second reflective polarizing layer P2 reflects one of the first polarized light and the second polarized light and transmits the other.

The optical device 10 of FIG. 1 includes the first and second lenses Z1 and Z2 which are plano-convex lenses, the half mirror HM located between the first and second lenses Z1 and Z2, the first reflective polarizing layer P1 disposed along the convex surface T1 of the first lens Z1, and the second reflective polarizing layer P2 disposed along the convex surface T2 of the second lens Z2. This makes it possible to shorten an optical path while increasing a light extraction efficiency, and thus the size of the optical device 10 can be reduced.

In FIG. 1, at least one of the first or second reflective polarizing layer P1 or P2 may include a Cholesteric LC layer. At least one of the first or second reflective polarizing layer P1 or P2 may be the Cholesteric LC layer, and each of the first and second reflective polarizing layers P1 and P2 may be the Cholesteric LC layer. The Cholesteric LC layer has a characteristic of reflecting circularly-polarized light while maintaining a rotation direction thereof.

At least one of the first reflective polarizing layer P1 or the second reflective polarizing layer P2 may be a single-layer reflective polarizing film having both functions of polarized reflection and polarized transmission. The first reflective polarizing layer P1 may be a single-layer reflective polarizing film adhered to the convex surface T1 with a pressure-sensitive adhesive layer (not illustrated) interposed therebetween, and the second reflective polarizing layer P2 may be a single-layer reflective polarizing film adhered to the convex surface T2 with a pressure-sensitive adhesive layer (not illustrated) interposed therebetween (the pressure-sensitive adhesive layer will be described later). The single-layer reflective polarizing film may be the Cholesteric LC layer.

At least one of the first reflective polarizing layer P1 or the second reflective polarizing layer P2 may have a thickness of 50 μm or less, and each of the first reflective polarizing layer P1 and the second reflective polarizing layer P2 may have a thickness of 50 μm or less. In this way, even when the radius of curvature of the convex surfaces T1 and T2 is reduced, the first and second reflective polarizing layers P1 and P2 are less likely to peel off, and the size of the optical device 10 can be further reduced.

For example, by using the Cholesteric LC layer for the first and second reflective polarizing layers P1 and P2, the first and second reflective polarizing layers P1 and P2 can be formed thin (50 μm or less, 20 μm or less, or 10 μm or less), and even when the radius of curvature of the convex surfaces T1 and T2 is reduced, the first and second reflective polarizing layers P1 and P2 are less likely to peel off. The Cholesteric LC layer may be included in a reflective polarizing film.

As illustrated in FIG. 1, cost reduction can be achieved by bringing the first and second lenses Z1 and Z2, which are symmetrically arranged, into close contact with each other with the half mirror HM interposed therebetween, but since the lens power is theoretically insufficient due to the close contact between the lenses, it is desirable to reduce the radius of curvature of the convex surfaces T1 and T2. Thus, it is desirable to apply, instead of a general reflective polarizer having a thickness exceeding 50 μm, the Cholesteric LC layer (Cholesteric LC film) that can be supplied in the form of a film having a thickness of several μm to several tens of μm to the first and second reflective polarizing layers P1 and P2.

As illustrated in FIG. 1, the first reflective polarizing layer P1 may be closer to the display device D than the second reflective polarizing layer P2. The optical device 10 may include a ¼λ layer Q1 (for example, a ¼ wavelength plate) closer to the display device D than the first reflective polarizing layer P1. The optical device 10 may include a ¼λ layer Q2 (for example, a ¼ wavelength plate) closer to the viewer U than the second reflective polarizing layer P2.

In the optical device 10, the ¼λ layer Q1, the first reflective polarizing layer P1, the first lens Z1, the half mirror HM, the second lens Z2, the second reflective polarizing layer P2, and a ½λ layer may be located in this order from the display device D side. The optical device 10 may include a polarizing material PA (a polarizing film, a polarizer, or the like) located between the ¼λ layer Q2 and the viewer U. The polarizing material PA may have a characteristic of absorbing light other than the polarized light emitted from the ¼λ layer Q2.

The half mirror HM may be in contact with the first lens Z1 and the second lens Z2. For example, the plane F1 of the first lens Z1 and the plane F2 of the second lens Z2 may be in contact with the half mirror HM. The first and second lenses Z1 and Z2 may be arranged symmetrically with respect to the half mirror HM. For example, the first and second lenses Z1 and Z2 may be the same plano-convex lens, and a distance between the half mirror HM and the convex surface T1 and a distance between the half mirror HM and the convex surface T2 may be equal to each other.

In the optical device 10 of FIG. 1, the first reflective polarizing layer P1 may transmit the first polarized light and reflect the second polarized light, and the second reflective polarizing layer P2 may reflect the first polarized light and transmit the second polarized light. One of the first polarized light and the second polarized light may be left handed circularly-polarized light, and the other may be right handed circularly-polarized light, and the rotation direction of the circularly-polarized light may be maintained in the reflection by each of the first reflective polarizing layer P1 and the second reflective polarizing layer P2.

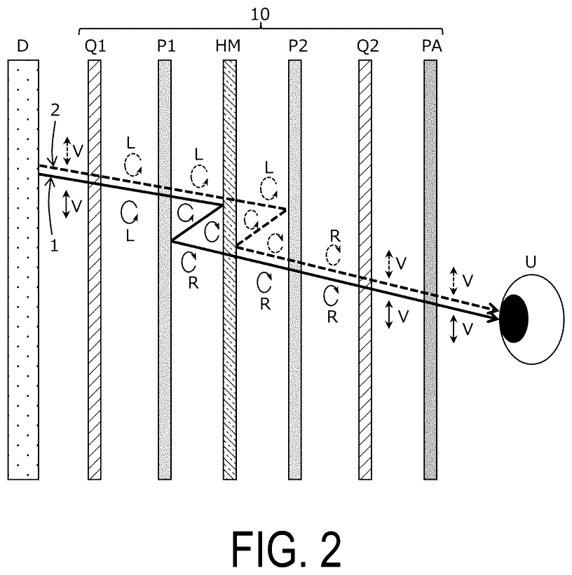

FIG. 2 is a schematic view illustrating two optical paths (double path) of the optical device of FIG. 1. In FIG. 2, the first reflective polarizing layer P1 transmits the left handed circularly-polarized light (first polarized light) and reflects the right handed circularly-polarized light (second polarized light), and the second reflective polarizing layer P2 reflects the left handed circularly-polarized light (first polarized light) and transmits the right handed circularly-polarized light (second polarized light).

A first path 1 in a case in which vertically polarized light V is emitted from the display device D is as follows. The vertically polarized light V from the display device D is converted into left handed circularly-polarized light L by the ¼λ layer Q1, and the left handed circularly-polarized light L is transmitted through the first reflective polarizing layer P1 and reflected by the half mirror HM to be converted into right handed circularly-polarized light R. The right handed circularly-polarized light reflected by the half mirror HM is reflected by the first reflective polarizing layer P1 (the right handed circularly-polarized light is maintained). The right handed circularly-polarized light R reflected by the first reflective polarizing layer P1 is transmitted through the half mirror HM and the second reflective polarizing layer P2 and is converted into the vertically polarized light V by the ¼λ layer Q2, and the vertically polarized light V is transmitted through the polarizing material PA and reaches the viewer U.

A second path 2 in a case in which the vertically polarized light V is emitted from the display device D is as follows. The vertically polarized light V from the display device D is converted into the left handed circularly-polarized light L by the ¼λ layer Q1, and the left handed circularly-polarized light L is transmitted through the first reflective polarizing layer P1 and the half mirror HM and is reflected by the second reflective polarizing layer P2 (the left handed circularly-polarized light is maintained). The left handed circularly-polarized light reflected by the second reflective polarizing layer P2 is reflected by the half mirror HM to be converted into the right handed circularly-polarized light R. The right handed circularly-polarized light R reflected by the half mirror HM is transmitted through the second reflective polarizing layer P2 and is converted into the vertically polarized light V by the ¼λ layer Q2, and the vertically polarized light V is transmitted through the polarizing material PA and reaches the viewer U.

In the optical device 10, light (light passing through the first path 1) emitted from the display device D, reflected by the half mirror HM and the first reflective polarizing layer P1, and directed toward the viewer U and light (light passing through the second path 2) emitted from the display device D, reflected by the second reflective polarizing layer P2 and the half mirror HM, and directed toward the viewer U are superimposed on each other. This makes it possible to shorten the optical path while increasing the light extraction efficiency.

In FIG. 2, the case in which the vertically polarized light is emitted from the display device D has been described, but the disclosure is not limited thereto. In a case in which horizontally polarized light is emitted from the display device D, the first and second reflective polarizing layers P1 and P2 may be exchanged, the second reflective polarizing layer P2 (which reflects the left handed circularly-polarized light and transmits the right handed circularly-polarized light) may be disposed on the display device D side, and the first reflective polarizing layer P1 (which transmits the left handed circularly-polarized light and reflects the right handed circularly-polarized light) may be disposed on the viewer U side. The display device D may be a liquid crystal display device or a self-luminous display device including, for example, a light-emitting diode (an organic LED, an inorganic crystal LED, a quantum dot LED, or the like).

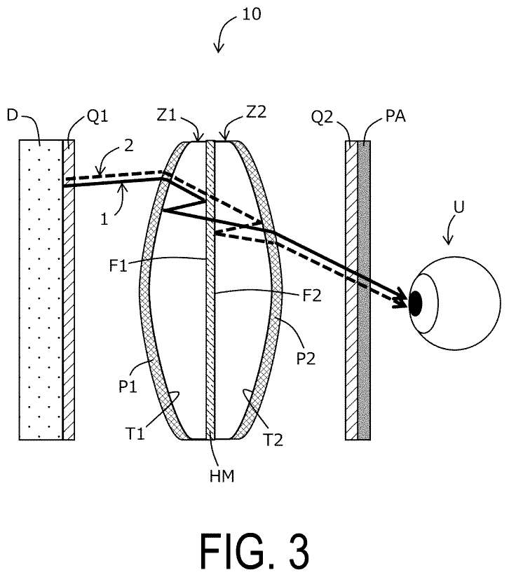

FIG. 3 is a cross-sectional view illustrating a configuration example of an optical device according to the present embodiment. As illustrated in FIG. 3, in the optical device 10, a PVH layer may be used for each of the first reflective polarizing layer P1 (which, for example, transmits the left handed circularly-polarized light and reflects the right handed circularly-polarized light) and the second reflective polarizing layer P2 (which, for example, reflects the left handed circularly-polarized light and transmits the right handed circularly-polarized light). The PVH layer has a structure in which the Cholesteric LC layer is disposed on an alignment film having a periodic pattern formed by photo-alignment, and has a function of a concave surface mirror in addition to a function of non-axial reflection. The function of the concave surface mirror can improve the degree of freedom in design by one surface.

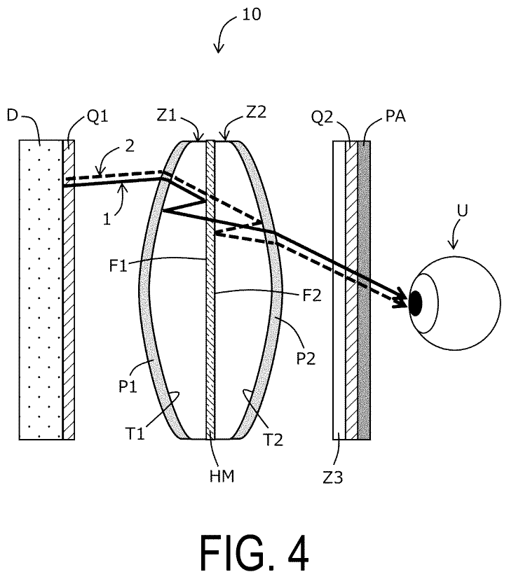

FIG. 4 is a cross-sectional view illustrating a configuration example of an optical device according to the present embodiment. As illustrated in FIG. 4, the optical device 10 may include a third lens Z3 closer to the viewer U than the second reflective polarizing layer P2. The third lens Z3 may be disposed between the second reflective polarizing layer P2 and the ¼λ layer Q2. The third lens Z3 may be disposed between the ¼λ layer Q2 and the polarizing material PA. The third lens Z3 may be a diffraction lens, and the diffraction lens may be a Pancharatnam-Berry (PB) lens. The PB lens can be provided with a function corresponding to an aspherical lens by non-uniformly forming a pattern period. An additional lens may be superimposed on the third lens Z3.

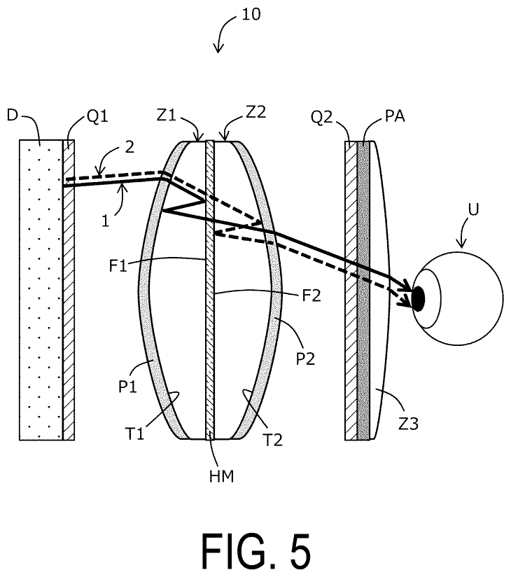

FIG. 5 is a cross-sectional view illustrating a configuration example of an optical device according to the present embodiment. As illustrated in FIG. 5, the optical device 10 may include the third lens Z3 closer to the viewer U than the second reflective polarizing layer P2, and the third lens Z3 may be disposed between the polarizing material PA and the viewer U. The third lens Z3 may be a plano-convex lens in which a surface on a side close to the half mirror HM is a plane and a surface on a side close to the viewer U is a convex surface.

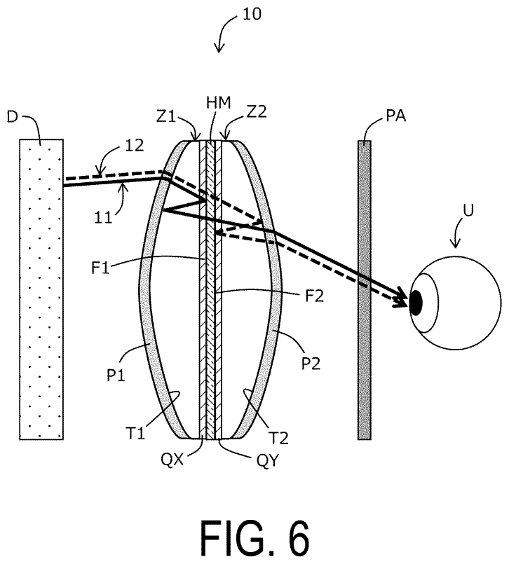

FIG. 6 is a cross-sectional view illustrating a configuration example of an optical device according to the present embodiment. The optical device 10 illustrated in FIG. 6 includes a first reflective polarizing layer P1, a second reflective polarizing layer P2, a half mirror HM, a first lens Z1, and a second lens Z2. The half mirror HM is located between the first reflective polarizing layer P1 and the second reflective polarizing layer P2. The first lens Z1 is located between the first reflective polarizing layer P1 and the half mirror HM. The second lens Z2 is located between the second reflective polarizing layer P2 and the half mirror HM. The optical device 10 is located between a display device D and a viewer U, and the first reflective polarizing layer P1, the first lens Z1, the half mirror HM, the second lens Z2, and the second reflective polarizing layer P2 are located in this order from the display device D toward the viewer U.

The first lens Z1 is a plano-convex lens in which a surface on a side close to the half mirror HM is a plane F1 and a surface on a side far from the half mirror HM (a surface on a side close to the display device D) is a convex surface T1. The second lens Z2 is a plano-convex lens in which a surface on a side close to the half mirror HM is a plane F2 and a surface on a side far from the half mirror HM (a surface on a side close to the viewer U) is a convex surface T2.

The first reflective polarizing layer P1 is disposed along the convex surface T1 of the first lens Z1. The second reflective polarizing layer P2 is disposed along the convex surface T2 of the second lens Z2. The first reflective polarizing layer P1 and the convex surface T1 may be in contact with each other or may be separated from each other. The second reflective polarizing layer P2 and the convex surface T2 may be in contact with each other or may be separated from each other.

The optical device 10 of FIG. 6 includes the first and second lenses Z1 and Z2 which are plano-convex lenses, the half mirror HM located between the first and second lenses Z1 and Z2, the first reflective polarizing layer P1 disposed along the convex surface T1 of the first lens Z1, and the second reflective polarizing layer P2 disposed along the convex surface T2 of the second lens Z2. This makes it possible to shorten an optical path while increasing a light extraction efficiency, and thus the size of the optical device 10 can be reduced.

At least one of the first or second reflective polarizing layer P1 or P2 may be a wire grid layer, and each of the first and second reflective polarizing layers P1 and P2 may be the wire grid layer. The wire grid layer can be formed by microfabrication (dry etching or the like) of a metal layer. The wire grid layer has a characteristic of reflecting linearly polarized light while maintaining the polarization direction thereof.

The optical device 10 of FIG. 6 may include a ¼λ layer QX (for example, a ¼ wavelength plate) located between the half mirror HM and the first lens Z1, and a ¼λ layer QY located between the half mirror HM and the second lens Z2.

In the optical device 10, the first reflective polarizing layer P1, the first lens Z1, the ¼λ layer QX, the half mirror HM, the ¼λ layer QY, the second lens Z2, and the second reflective polarizing layer P2 may be located in this order from the display device D side. The optical device 10 may include the polarizing material PA (a polarizing film, a polarizer, or the like) located between the second reflective polarizing layer P2 and the viewer U. The polarizing material PA may have a characteristic of absorbing light other than the polarized light emitted from the second reflective polarizing layer P2.

In the optical device 10 of FIG. 6, the first reflective polarizing layer P1 may transmit the first polarized light and reflect the second polarized light, and the second reflective polarizing layer P2 may reflect the first polarized light and transmit the second polarized light. One of the first polarized light and the second polarized light may be the vertically polarized light, and the other may be the horizontally polarized light, and the polarization direction may be maintained in the reflection by each of the first reflective polarizing layer P1 and the second reflective polarizing layer P2.

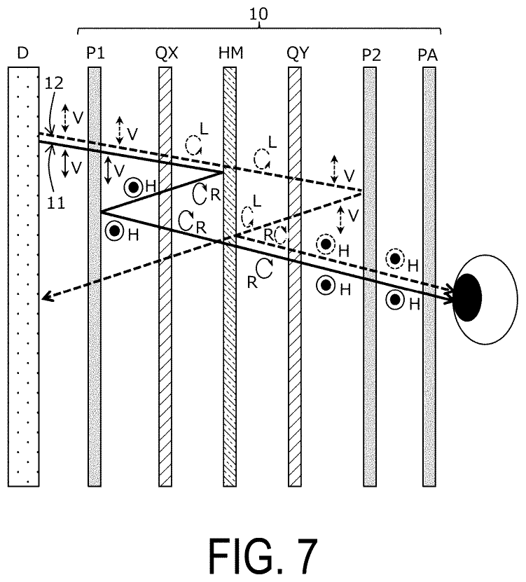

FIG. 7 is a schematic view illustrating two optical paths (double path) of the optical device of FIG. 6. In FIG. 7, the first reflective polarizing layer P1 transmits vertically polarized light (first polarized light) and reflects horizontally polarized light (second polarized light), and the second reflective polarizing layer P2 reflects the vertically polarized light (first polarized light) and transmits the horizontally polarized light (second polarized light).

A first path 11 in a case in which the vertically polarized light V is emitted from the display device D is as follows. The vertically polarized light V from the display device D is transmitted through the first reflective polarizing layer P1 and is converted into the left handed circularly-polarized light L by the ¼λ layer QX. The left handed circularly-polarized light L is reflected by the half mirror HM and is converted into the right handed circularly-polarized light R. The right handed circularly-polarized light R reflected by the half mirror HM is converted into horizontally polarized light H by the ¼λ layer QX, and is reflected by the first reflective polarizing layer P1. The horizontally polarized light H reflected by the first reflective polarizing layer P1 is converted into the right handed circularly-polarized light R by the ¼λ layer QX. The right handed circularly-polarized light R is transmitted through the half mirror HM and is converted into the horizontally polarized light H by the ¼λ layer QY. The horizontally polarized light H is transmitted through the second reflective polarizing layer P2 and the polarizing material PA and reaches the viewer U.

A second path 12 in a case in which the vertically polarized light V is emitted from the display device D is as follows. The vertically polarized light V from the display device D is transmitted through the first reflective polarizing layer P1 and is converted into the left handed circularly-polarized light L by the ¼λ layer QX. The left handed circularly-polarized light L is transmitted through the half mirror HM, is converted into the vertically polarized light V by the ¼λ layer QY, and is reflected by the second reflective polarizing layer P2. The vertically polarized light V reflected by the second reflective polarizing layer P2 is converted into the left handed circularly-polarized light L by the ¼λ layer QY. The left handed circularly-polarized light L is reflected by the half mirror HM and is converted into the right handed circularly-polarized light R. The right handed circularly-polarized light R reflected by the half mirror HM is converted into the horizontally polarized light H by the ¼λ layer QY. The horizontally polarized light H is transmitted through the second reflective polarizing layer P2 and the polarizing material PA and reaches the viewer U.

In the optical device 10 of FIG. 6, light (light passing through the first path 11) emitted from the display device D, reflected by the half mirror HM and the first reflective polarizing layer P1, and directed toward the viewer U and light (light passing through the second path 12) emitted from the display device D, reflected by the second reflective polarizing layer P2 and the half mirror HM, and directed toward the viewer U are superimposed on each other. This makes it possible to shorten the optical path while increasing the light extraction efficiency.

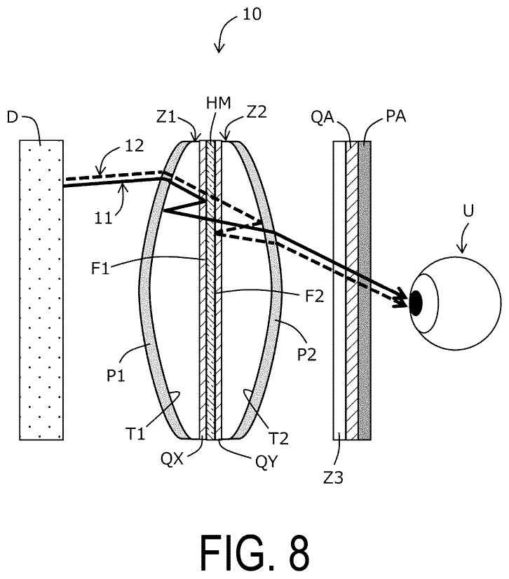

FIG. 8 is a cross-sectional view illustrating a configuration example of an optical device according to the present embodiment. As illustrated in FIG. 8, the optical device 10 may include a third lens Z3 closer to the viewer U than the second reflective polarizing layer P2. The ¼λ layer QA may be disposed between the third lens Z3 and the polarizing material PA, and the third lens Z3 may be disposed between the second reflective polarizing layer P2 and the ¼λ layer QA. The third lens Z3 may be a diffraction lens, and the diffraction lens may be a Pancharatnam-Berry (PB) lens.

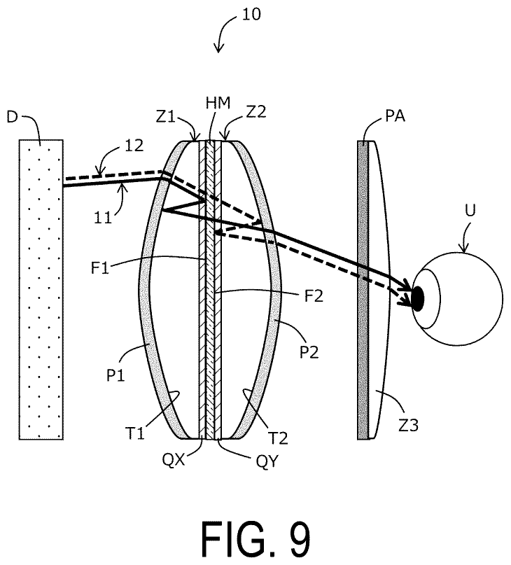

FIG. 9 is a cross-sectional view illustrating a configuration example of an optical device according to the present embodiment. As illustrated in FIG. 9, the optical device 10 may include the third lens Z3 closer to the viewer U than the second reflective polarizing layer P2, and the third lens Z3 may be disposed between the polarizing material PA and the viewer U. The third lens Z3 may be a plano-convex lens in which a surface on a side close to the half mirror HM is a plane and a surface on a side close to the viewer U is a convex surface.

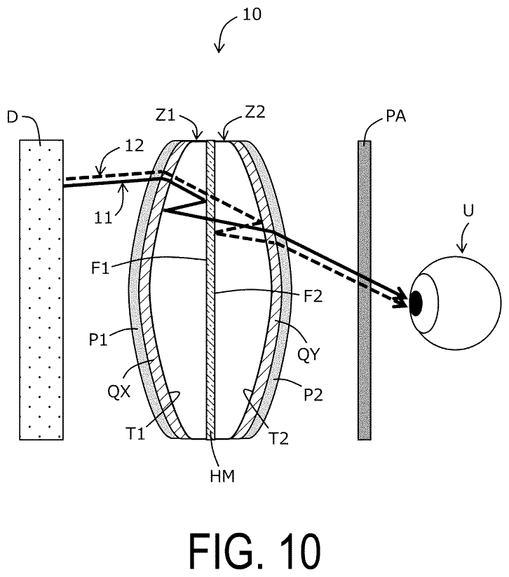

FIG. 10 is a cross-sectional view illustrating a configuration example of an optical device according to the present embodiment. As illustrated in FIG. 10, in the optical device 10, the ¼λ layer QX may be disposed between the first lens Z1 and the first reflective polarizing layer P1, and the ¼λ layer QY may be disposed between the second lens Z2 and the second reflective polarizing layer P2. For example, the first reflective polarizing layer P1, the ¼λ layer QX, the first lens Z1, the half mirror HM, the second lens Z2, the ¼λ layer QY, and the second reflective polarizing layer P2 are located in this order from the display device D side. In this case, the ¼λ layer QX is disposed along the convex surface T1 of the first lens Z1, and the first reflective polarizing layer P1 is disposed along the convex surface T1 with the ¼λ layer QX interposed therebetween. In addition, the ¼λ layer QY is disposed along the convex surface T2 of the second lens Z2, and the second reflective polarizing layer P2 is disposed along the convex surface T2 with the ¼λ layer QY interposed therebetween. In FIG. 10, the ¼λ layer QX may be applied and formed on the convex surface T1, and the ¼λ layer QY may be applied and formed on the convex surface T2.

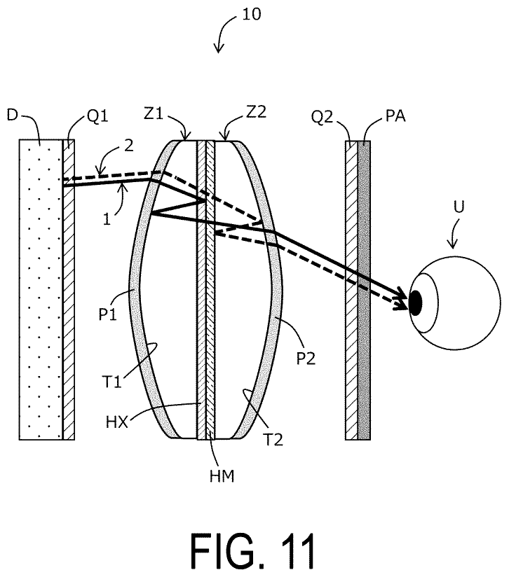

FIG. 11 is a cross-sectional view illustrating a configuration example of an optical device according to the present embodiment. The optical device 10 illustrated in FIG. 11 includes a ½λ layer (for example, a half-wavelength layer, a half-wavelength film, or a half-wavelength plate) located between the first reflective polarizing layer P1 and the half mirror HM. In the optical device 10 of FIG. 11, the ¼λ layer Q1, the first reflective polarizing layer P1, the first lens Z1, a ½λ layer HX, the half mirror HM, the second lens Z2, the second reflective polarizing layer P2, and the ¼λ layer Q2 are located in this order from the display device D side. The ½λ layer may be located between the first reflective polarizing layer P1 and the first lens Z1.

In FIG. 11, at least one of the first or second reflective polarizing layer P1 or P2 may include the Cholesteric LC layer. At least one of the first or second reflective polarizing layer P1 or P2 may be the Cholesteric LC layer, and each of the first and second reflective polarizing layers P1 and P2 may be the Cholesteric LC layer. The Cholesteric LC layer has a characteristic of reflecting circularly-polarized light while maintaining a rotation direction thereof.

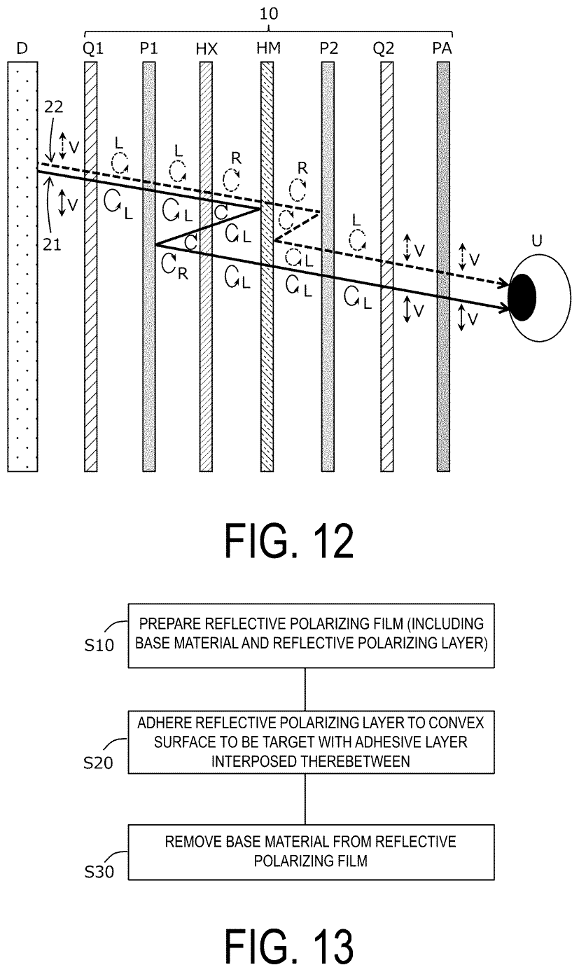

FIG. 12 is a schematic view illustrating two optical paths (double path) of the optical device of FIG. 11. In FIG. 12, the first and second reflective polarizing layers P1 and P2 have the same optical characteristics. For example, each of the first and second reflective polarizing layers P1 and P2 transmits the left handed circularly-polarized light (first polarized light) and reflects the right handed circularly-polarized light (second polarized light).

A first path 21 in a case in which vertically polarized light V is emitted from the display device D is as follows. The vertically polarized light V from the display device D is converted into left handed circularly-polarized light L by the ¼λ layer Q1, and the left handed circularly-polarized light L is transmitted through the first reflective polarizing layer P1 and is converted into the right handed circularly-polarized light by the ½λ layer HX. The right handed circularly-polarized light from the ½λ layer HX is reflected by the half mirror HM and is converted into the left handed circularly-polarized light L. The left handed circularly-polarized light L reflected by the half mirror HM is converted into right handed circularly-polarized light by the ½λ layer HX, and the right handed circularly-polarized light is reflected by the first reflective polarizing layer P1 (the right handed circularly-polarized light is maintained). The right handed circularly-polarized light R reflected by the first reflective polarizing layer P1 is converted into left handed circularly-polarized light L by the ½λ layer HX, the left handed circularly-polarized light L is transmitted through the half mirror HM and the second reflective polarizing layer P2, the left handed circularly-polarized light L is converted into vertically polarized light V by the ¼λ layer Q2, and the vertically polarized light V is transmitted through the polarizing material PA and reaches the viewer U.

A second path 22 in a case in which the vertically polarized light V is emitted from the display device D is as follows. The vertically polarized light V from the display device D is converted into left handed circularly-polarized light L by the ¼λ layer Q1, and the left handed circularly-polarized light L is transmitted through the first reflective polarizing layer P1 and is converted into the right handed circularly-polarized light by the ½λ layer HX. The right handed circularly-polarized light from the ½λ layer HX is transmitted through the half mirror HM and reflected by the second reflective polarizing layer P2 (the right handed circularly-polarized light is maintained). The right handed circularly-polarized light R reflected by the second reflective polarizing layer P2 is reflected by the half mirror HM and is converted into the left handed circularly-polarized light L. The left handed circularly-polarized light L reflected by the half mirror HM is transmitted through the second reflective polarizing layer P2 and is converted into the vertically polarized light V by the ¼λ layer Q2, and the vertically polarized light V is transmitted through the polarizing material PA and reaches the viewer U.

In the optical device 10 of FIG. 11, light (light passing through the first path 21) emitted from the display device D, reflected by the half mirror HM and the first reflective polarizing layer P1, and directed toward the viewer U and light (light passing through the second path 22) emitted from the display device D, reflected by the second reflective polarizing layer P2 and the half mirror HM, and directed toward the viewer U are superimposed on each other. This makes it possible to shorten the optical path while increasing the light extraction efficiency.

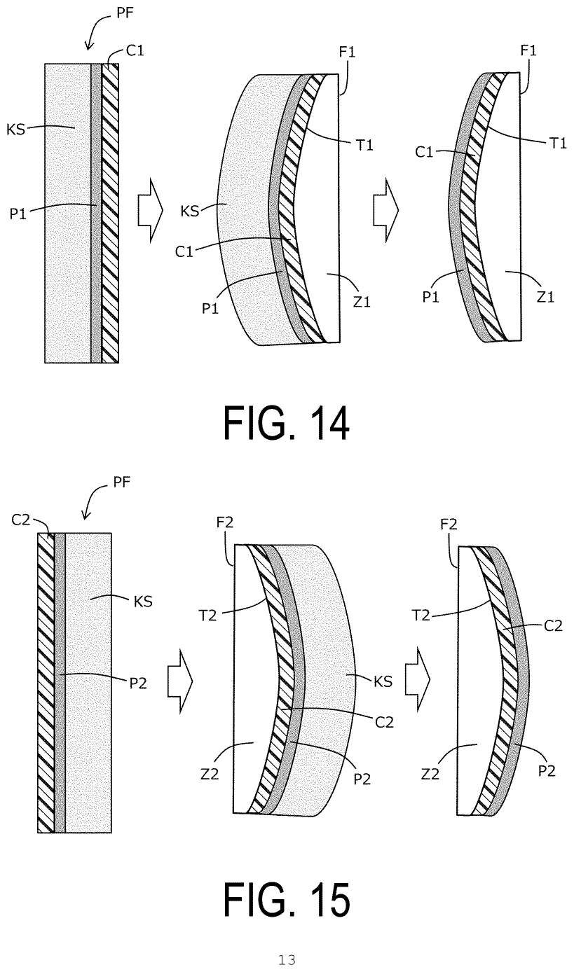

FIG. 13 is a flowchart illustrating an example of a manufacturing method for the optical device according to the present embodiment. FIGS. 14 and 15 are cross-sectional views each illustrating an example of the manufacturing method for the optical device according to the present embodiment. As illustrated in FIGS. 13 and 14, the manufacturing method for the optical device includes step S10 of preparing a reflective polarizing film PF (including a base material KS and the first reflective polarizing layer P1), step S20 of adhering the first reflective polarizing layer P1 to the convex surface T1 to be a target with an adhesive layer C1 interposed therebetween, and step S30 of removing the base material KS from the reflective polarizing film PF (FIG. 14). As illustrated in FIG. 15, a step of preparing the reflective polarizing film PF (including the base material KS and the second reflective polarizing layer P2), a step of adhering the second reflective polarizing layer P2 to the convex surface T2 to be a target with an adhesive layer C2 interposed therebetween, and a step of removing the base material KS from the reflective polarizing film PF may be performed.

As illustrated in FIGS. 14 and 15, the first reflective polarizing layer P1 is adhered to the convex surface T1 of the first lens with the first adhesive layer C1 interposed therebetween, and the second reflective polarizing layer P2 is adhered to the convex surface T2 of the second lens with the second adhesive layer C2 interposed therebetween. The thickness of each of the first and second adhesive layers C1 and C2 may be 25 μm or more.

In the reflective polarizing film PF, the base material KS may be disposed on one surface or both surfaces. The first reflective polarizing layer P1 may be the Cholesteric LC layer (polarization-controlling liquid crystal layer) or a wire grid layer (polarization-controlling metallic layer). The thickness of the Cholesteric LC layer may be from 2 μm to 5 μm. The thickness of the wire grid layer may be from 2 μm to 5 μm. The thickness of the base material KS may be from 50 μm to 200 μm.

The first reflective polarizing layer P1 may be monolithically formed on the convex surface T1. In a case in which the first reflective polarizing layer P1 is the Cholesteric LC layer, for example, the first reflective polarizing layer P1 can be monolithically formed by coating a polyimide film on the convex surface T1 and curing the Cholesteric LC layer coated on the polyimide film with ultraviolet light. When the first reflective polarizing layer P1 is a wire grid layer, the wire grid layer can be monolithically formed on the convex surface T1 by using, for example, a stamper of nanoimprint on the convex surface T1.

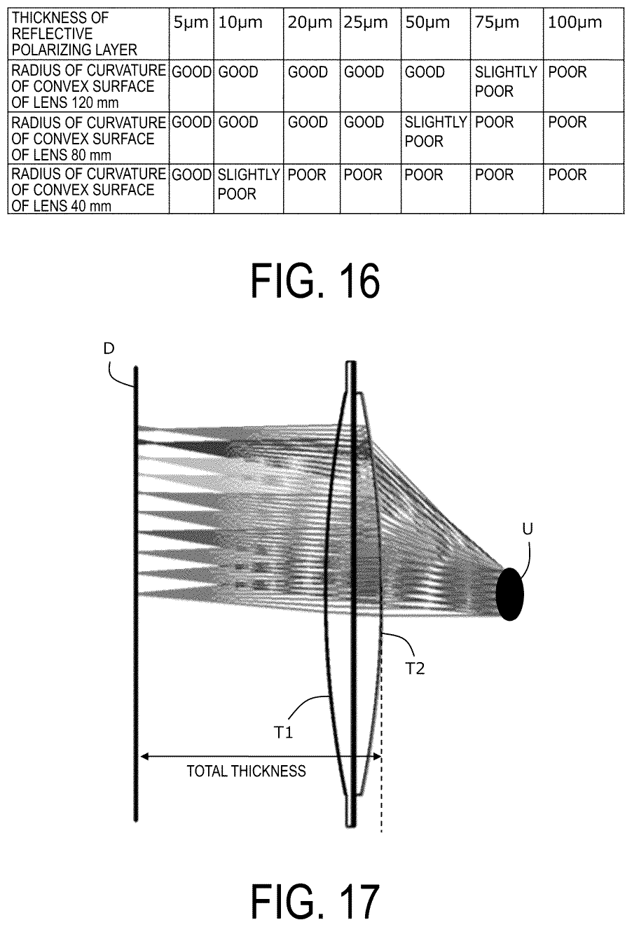

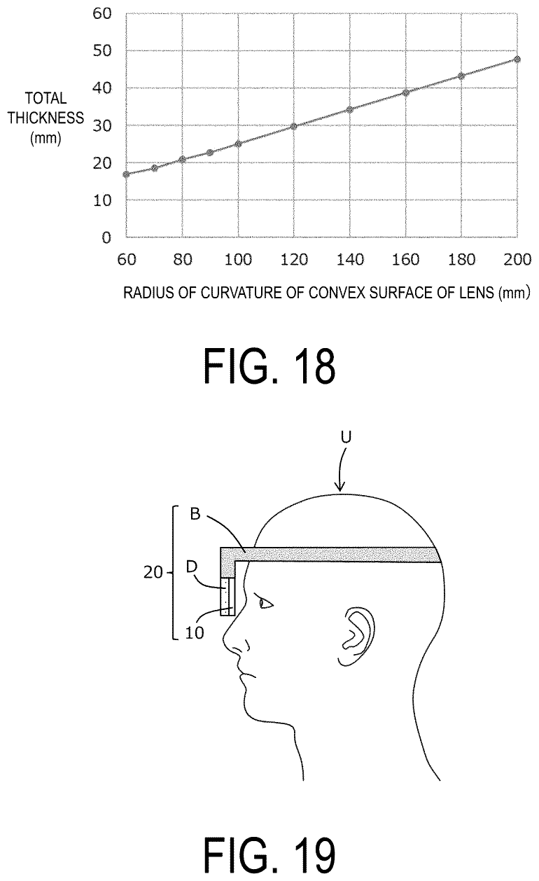

FIG. 16 is a table showing a relationship of an adhesion accuracy of a reflective polarizing layer and a combination of a thickness of the reflective polarizing layer and a radius of curvature of a convex surface of a lens. FIG. 17 is a cross-sectional view illustrating a total thickness from a display device to a convex surface of a second lens. FIG. 18 is a graph showing a relationship between a radius of curvature of a convex surface of a lens and a total thickness. The definitions of “good”, “slightly poor”, and “poor” in FIG. 16 are as follows. “Good”: The reflective polarizing layer is not spontaneously separated from the convex surface. “Slightly poor”: The reflective polarizing layer spontaneously separates from the convex surface after one day. “Poor”: The reflective polarizing layer spontaneously separates from the convex surface immediately. In FIGS. 16 to 18, the plano-convex lenses (Z1 and Z2) are made of polymethyl methacrylate (PMMA), and the refractive index of PMMA is 1.49.

From FIGS. 16 to 18, it is understood that thinning the reflective polarizing layers (P1 and P2) is effective for improving the adhesion accuracy. When the reflective polarizing layers (P1 and P2) are disposed along the convex surfaces (T1 and T2), respectively, the tensile stress and the compressive stress acting in the planes of the reflective polarizing layers are preferably made uniform, and from this, the thicknesses of the pressure sensitive adhesive layers (C1 and C2) are preferably 25 μm or more. In addition, in the step of causing the reflective polarizing layer to conform to the convex surface, it is also effective to heat at least one of the reflective polarizing layer and or convex surface.

According to FIG. 16, when the radius of curvature of the convex surface is 120 mm, the reflective polarizing layer does not spontaneously separate from the convex surface when the thickness of the reflective polarizing layer is 50 μm or less. When the radius of curvature of the convex surface is 80 mm, the reflective polarizing layer does not spontaneously separate from the convex surface when the thickness of the reflective polarizing layer is 25 μm or less. When the radius of curvature of the convex surface is 40 mm, the reflective polarizing layer does not spontaneously separate from the convex surface when the thickness of the reflective polarizing layer is 5 μm or less. From the above, the thicknesses of the reflective polarizing layers (P1 and P2) are preferably 50 μm or less, 25 μm or less, and further 5 μm or less.

In FIGS. 17 and 18, in order to achieve the total thickness of 40 mm or less in a Fresnel lens system, the radius of curvature of the convex surface may be 160 mm or less. That is, the radius of curvature of the convex surface of at least one of the first lens Z1 or the second lens Z2, which are plano-convex lenses, is preferably 160 mm or less. A lens material such as PMMA tends to turn yellow due to the absorption of blue light. When the radius of curvature of the convex surface is less than 40 mm, the thickness of the plano-convex lens is too large, and an image may be yellowish or an optical aberration may be adversely affected. From this, the radius of curvature of the convex surface of at least one of the first lens Z1 or the second lens Z2 is preferably 40 mm or more.

FIG. 19 is a schematic cross-sectional view illustrating a configuration example of a head-mounted display according to the present embodiment. As illustrated in FIG. 19, a head-mounted display 20 may include the optical device 10, the display device D, and a mounting unit B that is mounted on the head of the viewer U while holding the optical device 10 and the display device D.

### Supplement

An optical device according to a first aspect of the disclosure includes a first reflective polarizing layer and a second reflective polarizing layer, a half mirror located between the first reflective polarizing layer and the second reflective polarizing layer, a first lens located between the first reflective polarizing layer and the half mirror, and a second lens located between the second reflective polarizing layer and the half mirror, in which the first lens is a plano-convex lens having a plane on a side close to the half mirror, the second lens is a plano-convex lens having a plane on a side close to the half mirror, the first reflective polarizing layer is disposed along a convex surface of the first lens, the second reflective polarizing layer is disposed along a convex surface of the second lens, the first reflective polarizing layer transmits first polarized light and reflects second polarized light, and the second reflective polarizing layer reflects one of the first polarized light and the second polarized light and transmits the other.

In the optical device according to a second aspect of the disclosure, in the first aspect, at least one of the first reflective polarizing layer or the second reflective polarizing layer has a thickness of 50 μm or less.

In the optical device according to a third aspect of the disclosure, in the first or second aspect, one of the first polarized light and the second polarized light is right handed circularly-polarized light, and the other is left handed circularly-polarized light, and a rotation direction of circularly-polarized light is maintained in reflection by each of the first reflective polarizing layer and the second reflective polarizing layer.

In the optical device according to a fourth aspect of the disclosure, in the third aspect, the second reflective polarizing layer reflects the first polarized light and transmits the second polarized light.

In the optical device according to an aspect 5 of the disclosure, in any one of the first to fourth aspects, one of the first polarized light and the second polarized light is right handed circularly-polarized light, and the other is left handed circularly-polarized light, and at least one of the first reflective polarizing layer or the second reflective polarizing layer is a Cholesteric LC layer.

In the optical device according to a sixth aspect of the disclosure, in any one of the first to fourth aspects, one of the first polarized light and the second polarized light is right handed circularly-polarized light, and the other is left handed circularly-polarized light, and at least one of the first reflective polarizing layer or the second reflective polarizing layer is a PVH layer.

In the optical device according to a seventh aspect of the disclosure, in any one of the first to fourth aspects, one of the first polarized light and the second polarized light is horizontally polarized light, and the other is vertically polarized light, and at least one of the first reflective polarizing layer or the second reflective polarizing layer is a wire grid layer.

In the optical device according to an eighth aspect of the disclosure, in any one of the first to seventh aspects, the half mirror is in contact with the first lens and the second lens.

The optical device according to a ninth aspect of the disclosure, in any one of the first to eighth aspects, further includes at least one of a ¼λ plate located between the half mirror and the first lens or a ¼λ plate located between the half mirror and the second lens.

In the optical device according to a tenth aspect of the disclosure, in any one of the first to ninth aspects, the first reflective polarizing layer and the second reflective polarizing layer are disposed between a display device and a viewer, and the first reflective polarizing layer is closer to the display device than the second reflective polarizing layer.

The optical device according to an eleventh aspect of the disclosure, in the tenth aspect, further includes a ¼λ plate closer to the display device than the first reflective polarizing layer.

The optical device according to a twelfth aspect of the disclosure, in the tenth or eleventh aspect, further includes a ¼λ plate closer to the viewer than the second reflective polarizing layer.

The optical device according to a thirteenth aspect of the disclosure, in any one of the tenth to twelfth aspects, further includes a third lens closer to the viewer than the second reflective polarizing layer.

In the optical device according to a fourteenth aspect of the disclosure, in the thirteenth aspect, the third lens is a diffraction lens.

In the optical device according to a fifteenth aspect of the disclosure, in the fourteenth aspect, the diffraction lens is a PB lens.

In the optical device according to a sixteenth aspect of the disclosure, in the thirteenth aspect, the third lens is a plano-convex lens having a plane on a side close to the half mirror.

In the optical device according to a seventeenth aspect of the disclosure, in any one of the first to sixteenth aspects, further includes a ½λ layer between the first reflective polarizing layer and the half mirror.

In the optical device according to an eighteenth aspect of the disclosure, in any one of the first to seventeenth aspects, at least one of the first reflective polarizing layer or the second reflective polarizing layer includes a single-layer thin film having both functions of polarized reflection and polarized transmission.

In the optical device according to a nineteenth aspect of the disclosures, in any one of the first to eighteenth aspects, a radius of curvature of the convex surface of at least one of the first lens or the second lens is from 40 mm to 160 mm.

In an optical device according to a twentieth aspect of the disclosure, in any one of the tenth to nineteenth aspects, the display device is a liquid crystal display device or a self-luminous display device.

In the optical device according to a twenty-first aspect of the disclosure, in any one of the first to twentieth aspects, the first reflective polarizing layer is adhered to the convex surface of the first lens with a first adhesive layer interposed therebetween, the second reflective polarizing layer is adhered to the convex surface of the second lens with a second adhesive layer interposed therebetween, and a thickness of at least one of the first adhesive layer or the second adhesive layer is 25 μm or more.

In the optical device according to a twenty-second aspect of the disclosure, in any one of the first to twenty-first aspects, the first lens and the second lens are symmetrically disposed with respect to the half mirror.

In the optical device according to a twenty-third aspect of the disclosure, in any one of the tenth to twenty-second aspects, light emitted from the display device, reflected by the second reflective polarizing layer and the half mirror, and directed toward the viewer, and light emitted from the display device, reflected by the half mirror and the first reflective polarizing layer, and directed toward the viewer are superimposed on each other.

A head-mounted display according to a twenty-fourth aspect of the disclosure, in any one of the first to twenty-third aspects, includes the optical device.

The examples described above are for the purpose of illustration and description of the disclosure and are not intended to be limiting. Many variations will be apparent to those skilled in the art based on these illustrations and descriptions, and these variations are included in the embodiments.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An optical device comprising:
a first reflective polarizing layer and a second reflective polarizing layer;
a half mirror located between the first reflective polarizing layer and the second reflective polarizing layer;
a first lens located between the first reflective polarizing layer and the half mirror; and
a second lens located between the second reflective polarizing layer and the half mirror,
wherein the first lens is a plano-convex lens having a plane on a side close to the half mirror,
the second lens is a plano-convex lens having a plane on a side close to the half mirror,
the first reflective polarizing layer is disposed along a convex surface of the first lens,
the second reflective polarizing layer is disposed along a convex surface of the second lens,
the first reflective polarizing layer transmits first polarized light and reflects second polarized light, and
the second reflective polarizing layer reflects one of the first polarized light and the second polarized light and transmits the other.

2. The optical device according to claim 1,
wherein at least one of the first reflective polarizing layer or the second reflective polarizing layer has a thickness of 50 μm or less.

3. The optical device according to claim 1,
wherein one of the first polarized light and the second polarized light is right handed circularly-polarized light, and the other is left handed circularly-polarized light, and
a rotation direction of circularly-polarized light is maintained in reflection by each of the first reflective polarizing layer and the second reflective polarizing layer.

4. The optical device according to claim 3,
wherein the second reflective polarizing layer reflects the first polarized light and transmits the second polarized light.

5. The optical device according to claim 1,
wherein one of the first polarized light and the second polarized light is right handed circularly-polarized light, and the other is left handed circularly-polarized light, and
at least one of the first reflective polarizing layer or the second reflective polarizing layer is a Cholesteric LC layer.

6. The optical device according to claim 1,
wherein one of the first polarized light and the second polarized light is right handed circularly-polarized light, and the other is left handed circularly-polarized light, and
at least one of the first reflective polarizing layer or the second reflective polarizing layer is a PVH layer.

7. The optical device according to claim 1,
wherein one of the first polarized light and the second polarized light is horizontally polarized light, and the other is vertically polarized light, and
at least one of the first reflective polarizing layer or the second reflective polarizing layer is a wire grid layer.

8. The optical device according to claim 1,
wherein the half mirror is in contact with the first lens and the second lens.

9. The optical device according to claim 1, further comprising:
at least one of a ¼λ layer located between the half mirror and the first lens or a ¼λ layer located between the half mirror and the second lens.

10. The optical device according to claim 1,
wherein the first reflective polarizing layer and the second reflective polarizing layer are disposed between a display device and a viewer, and
the first reflective polarizing layer is closer to the display device than the second reflective polarizing layer.

11. The optical device according to claim 10, further comprising:
a ¼λ layer closer to the display device than the first reflective polarizing layer.

12. The optical device according to claim 10, further comprising:
a ¼λ layer closer to the viewer than the second reflective polarizing layer.

13. The optical device according to claim 10, further comprising:
a third lens closer to the viewer than the second reflective polarizing layer.

14. The optical device according to claim 13,
wherein the third lens is a plano-convex lens having a plane on a side close to the half mirror.

15. The optical device according to claim 10, further comprising:
a ½λ layer between the first reflective polarizing layer and the half mirror.

16. The optical device according to claim 1,
wherein at least one of the first reflective polarizing layer or the second reflective polarizing layer includes a single-layer thin film having both functions of polarized reflection and polarized transmission.

17. The optical device according to claim 1,
wherein a radius of curvature of the convex surface of at least one of the first lens or the second lens is from 40 mm to 160 mm.

18. The optical device according to claim 1,
wherein the first reflective polarizing layer is adhered to the convex surface of the first lens with a first adhesive layer interposed therebetween,
the second reflective polarizing layer is adhered to the convex surface of the second lens with a second adhesive layer interposed therebetween, and
a thickness of at least one of the first adhesive layer or the second adhesive layer is 25 μm or more.

19. The optical device according to claim 1,
wherein the first lens and the second lens are symmetrically disposed with respect to the half mirror.

20. A head-mounted display comprising:
the optical device according to claim 1.
